(19) United States
(12) Patent Application Publication
(10) Pub. No.: US 2004/0204984 A1
(43) Pub. Date: Oct. 14, 2004

(54) Performance assessing system and method

(76) Inventors: Pu-Yang Yeh, Tu-Chen (TW); Xu-Liang Guo, Shenzhen (CN); Zhun Xiao, Shenzhen (CN)

Correspondence Address: WEI TE CHUNG, FOXCONN INTERNATIONAL, INC., 1650 MEMOREX DRIVE, SANTA CLARA, CA, 95050, US

(21) Appl. No.: 10/822,098

(22) Filed: Apr. 9, 2004

(30) Foreign Application Priority Data
Apr. 9, 2003 (TW) 92108172

(51) Int. Cl. G06F 17/60

(52) U.S. Cl. 705/11

(57) ABSTRACT

A performance assessing system includes an application server (1), a database (5) connected with the application server, and a number of client computers (3) connected with the database via a network (4). Each client computer provides an interface for a user to input an employee's number and a starting time, and for showing a performance report on the employee. The database stores a number of products machining documents and a number of performance assessing tables. The application server includes a series of function modules for collecting daily products schedule results from a product machining scheduling system (2), tracing machining statuses of the products, computing the employee's work hours, work efficiency and work quality, and generating the employee's performance report. A related method is also disclosed.

### BACKGROUND OF THE INVENTION

1. Field of the Invention

The present invention relates to systems and methods for human resource management, and particularly to systems and methods for performance assessing.

2. Description of Related Art

Performance assessment plays an important role in human resource management for enterprises large and small. Performance assessment has been researched and developed for many years, but how to assess an employee's performance equitably and objectively is still problematic for managers.

Most enterprises adopt conventional performance assessing methods, such as the four-evaluation method, the three-evaluation method, and so on. The four-evaluation method includes self-evaluation, mutual evaluation, manager evaluation, and public evaluation. The three-evaluation method includes self-evaluation, mutual evaluation, and manager evaluation. Because these methods often largely depend on people's subjective judgments, these methods do not necessarily provide good efficacious results.

It is desired to provide an information management tool to replace most activities routinely carried out by personnel in conducting performance assessment. In particular, it is desired that performance assessment mostly carried out by an information management tool yields objective and equitable assessments instead of skewed or inaccurate assessments tainted by personal judgments.

### SUMMARY OF THE INVENTION

An object of the present invention is to provide a performance assessing system which can assess employees' performances according to work hours, work efficiencies and work qualities.

Another object of the present invention is to provide a performance assessing method which can assess employees' performances according to work hours, work efficiencies and work qualities.

To achieve the first above-mentioned objective, a preferred embodiment of a performance assessing system of the present invention comprises a database and a plurality of client computers connected with an application server. Each client computer provides an interface for a user to input an employee's number and a starting time, and for showing a performance report according to the user's inquiries. The database is for storing a plurality of products machining documents and a plurality of performance assessing tables. The application server is connected with a product machining scheduling system. The application server is for collecting daily products schedule results, tracing machining statuses according to the schedule results, computing the employee's work hours, work efficiency, and work quality, and generating the employee's performance report. The application server comprises a machining status tracing module, a performance assessing module, and a performance report generating module. The machining status tracing module comprises a schedule results collecting sub-module for collecting the schedule results, and a finished products information maintaining sub-module for storing each product's machining status, actual starting time and actual finishing time in the products machining documents. The performance assessing module comprises a starting/finishing time record generating sub-module for generating a starting time record and a finishing time record according to the products machining documents, a work hours computing sub-module for computing work hours of the employee and storing the work hours in the performance assessing table of the employee, a work efficiency computing sub-module for computing a work efficiency of the employee and storing the work efficiency in the performance assessing table of the employee, and a work quality analyzing sub-module for analyzing a work quality of the employee and storing the work quality in the performance assessing table of the employee. The performance report generating module is for generating a performance report on the employee.

To achieve the second above-mentioned objective, a preferred performance assessing method of the present invention comprises the following steps: (a) receiving an employee's number and starting time; (b) collecting daily schedule results, and storing the daily schedule results in a products machining document; (c) storing actual starting time, actual finishing time, and machining status of each of products in the products machining document; (d) generating a starting time record and a finishing time record according to the products machining document; (e) computing work hours of the employee, and storing the work hours in a performance assessing table of the employee; (f) computing a work efficiency of the employee, and storing the work efficiency in the performance assessing table of the employee; (g) analyzing a work quality of the employee, and storing the work quality in the performance assessing table of the employee; and (h) generating a performance report on the employee.

Other objects, advantages and novel features of the present invention will be drawn from the following description of preferred embodiments of the present invention with the attached drawings, in which:

### BRIEF DESCRIPTION OF THE DRAWINGS

FIG. 1 schematically shows hardware infrastructure of a performance assessing system in accordance with the preferred embodiment of the present invention;

FIG. 2 is a schematic diagram showing function modules of an application server of the system of FIG. 1;

FIG. 3 is a data flow diagram of the preferred embodiment of the present invention; and

FIG. 4 is a flowchart of a preferred method for performance assessment of the present invention.

### DETAILED DESCRIPTION OF THE INVENTION

Reference will now be made to the drawing figures to describe the present invention in detail.

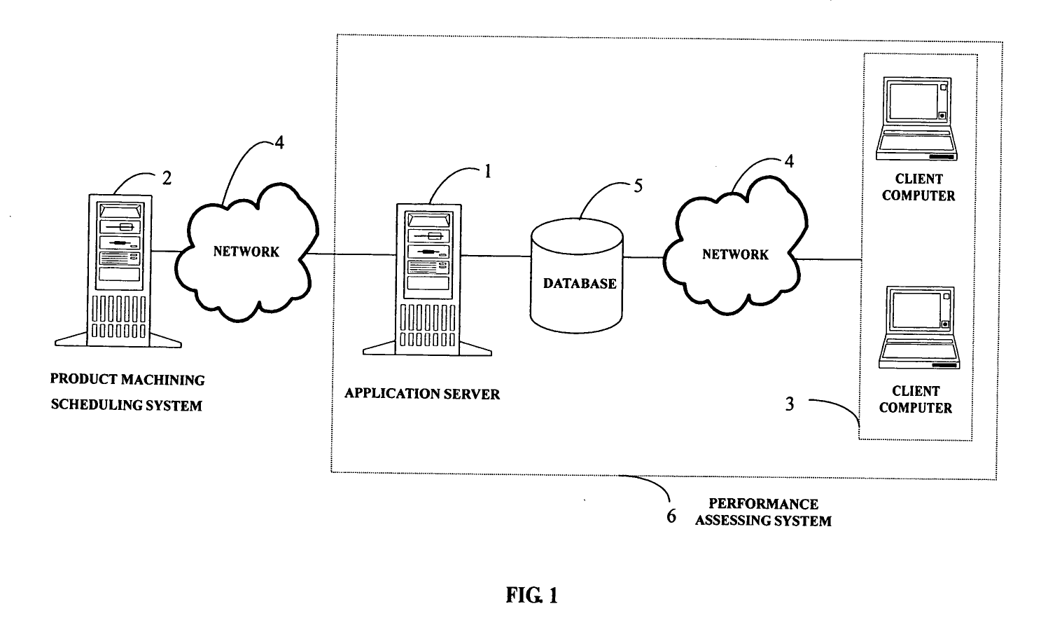

FIG. 1 schematically shows hardware infrastructure of a performance assessing system 6 in accordance with the preferred embodiment of the present invention. In the preferred embodiment, performance of employees working in a manufacturing enterprise is assessed. The performance assessing system 6 is connected with a product machining scheduling system 2 via a network 4. The performance assessing system 6 comprises an application server 1, a database 5 connected with the application server 1, and a plurality of client computers 3 connected with the database 5 via the network 4. The network 4 may be an intranet, the Internet, or an other suitable electronic communications network.

Each client computer 3 can be installed with a platform such as Microsoft Windows 95, Windows 98, or Windows NT. The client computer 3 provides an interface for a user to input an employee's number and a starting time, and for showing a performance report according to the user's inquiries. The product machining scheduling system 2 generates daily products machining schedule results. The database 5 stores detailed documents on products machining and performance assessing tables. The products machining documents comprise information on starting times, finishing times, and daily products schedule results generated by the product machining scheduling system 2. Each products machining document includes fields for product name, product number, scheduled starting time, scheduled finishing time, employee number, employee name, actual starting time, actual finishing time, and machining status. Each performance assessing table includes fields for employee number, employee name, work hours, work efficiency, and work quality. The application server 1 comprises a series of function modules for collecting daily products schedule results, tracing the machining statuses according to the schedule results, computing employees' work hours, work efficiencies, and work qualities, and generating employees' performance reports.

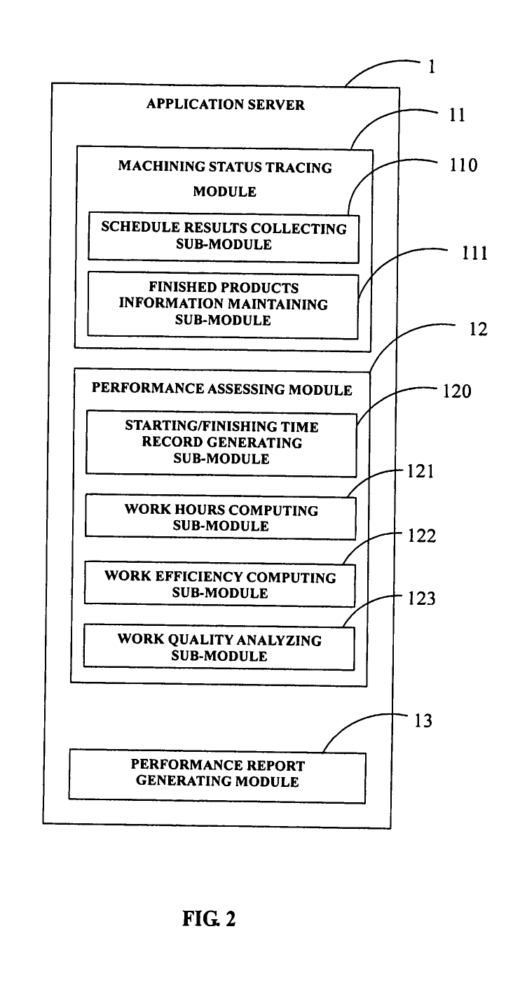

FIG. 2 is a schematic diagram showing function modules of the application server 1. The application server 1 comprises a machining status tracing module 11, a performance assessing module 12, and a performance report generating module 13. The machining status tracing module 11 is for tracing machining statuses of products according to schedule results received from the product machining scheduling system 2. The machining status tracing module 11 then records each product's machining status, actual starting time, and actual finishing time. The machining status tracing module 11 comprises a schedule results collecting sub-module 110, and a finished products information maintaining sub-module 111. The schedule results collecting sub-module 110 is for collecting daily schedule results from the product machining scheduling system 2, and storing the schedule results in the products machining documents. The schedule results comprise the scheduled starting time and the scheduled finishing time of each product. The finished products information maintaining sub-module 111 is for recording the actual starting times, the actual finishing times, and the machining statuses of the products in the performance assessing tables. A machining status may be unwrought, in progress, or finished.

The performance assessing module 12 is for generating a starting time record and a finishing time record for each product according to the products machining documents, computing employees' work hours and work efficiencies, analyzing the work qualities, and forming performance assessing tables for the employees. The performance assessing module 12 comprises a starting/finishing time record generating sub-module 120, a work hours computing sub-module 121, a work efficiency computing sub-module 122, and a work quality analyzing sub-module 123. The starting/finishing time record generating sub-module 120 is for generating the starting time record and the finishing time record according to the products machining documents. The work hours computing sub-module 121 is for computing work hours of employees, and storing the work hours in the performance assessing tables of the employees. The work hours is the sum of time periods of all the products finished by each employee. The time period of each product is the time span between the actual starting time and the actual finishing time. The work efficiency computing sub-module 122 is for computing the work efficiencies of the employees according to the products machining documents and storing the work efficiencies in the performance assessing tables of the employees. A work efficiency for each employee comprises a ratio of a scheduled work time and an actual work time for each of products finished by the employee. The scheduled work time is the scheduled finishing time minus the scheduled starting time of the product finished by the employ. The actual work time is the actual finishing time minus the actual starting time of the product finished by the employee. The work quality analyzing sub-module 123 is for checking and storing whether products are behind or ahead of schedule according to the machining statuses of the products in the employees' performance assessing tables. The work quality analyzing sub-module 123 is also for storing in the employees' performance assessing tables the results of quality inspection of the products performed by inspectors. The inspection result of a product may be passed or rejected. All the results stored by the work quality analyzing sub-module 123 are collectively regarded as the work quality of the respective employees.

The performance report generating module 13 is for generating performance reports on employees. The performance reports show the work hours, the work efficiencies, and the work qualities of the employees.

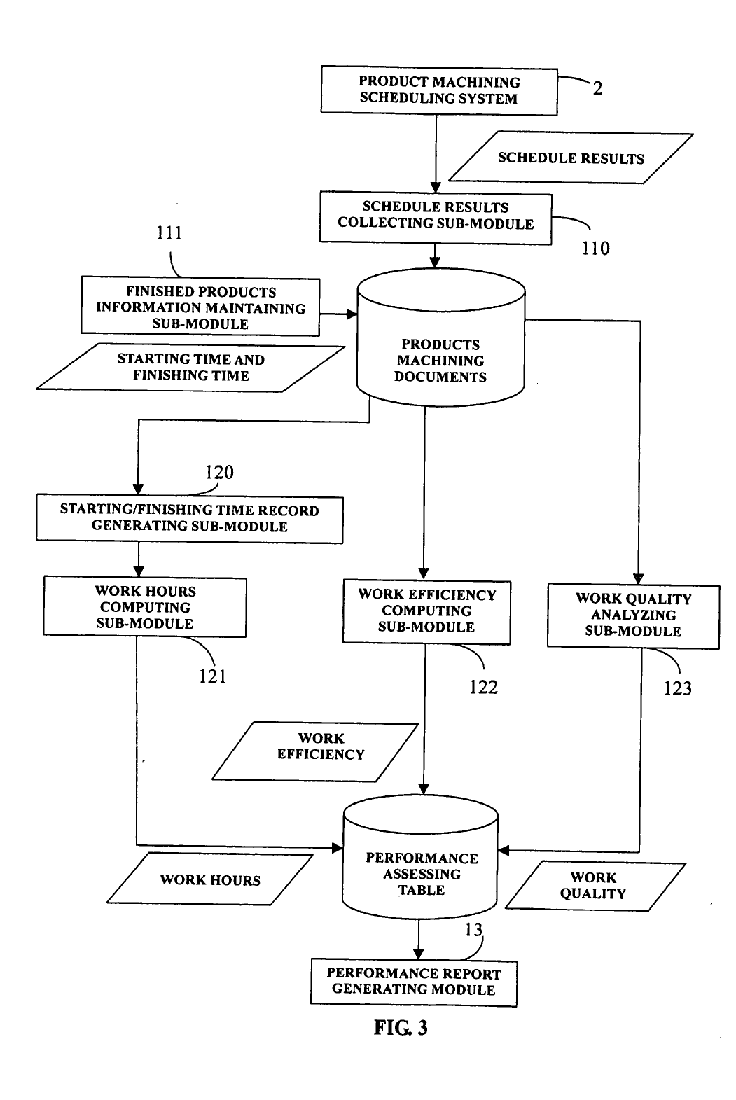

FIG. 3 is a data flow diagram of the preferred embodiment of the present invention. The schedule results collecting sub-module 110 collects daily schedule results from the product machining scheduling system 2, and stores the daily schedule results in the products machining documents. The finished products information maintaining sub-module 111 stores the starting times and the finishing times of the products in the products machining documents. According to the starting times and the finishing times of the products in the products machining documents, the starting/finishing time record generating sub-module 120 generates the starting time record and the finishing time record of each product. The work hours computing sub-module 121 computes the work hours of each employee and stores the work hours in the performance assessing table of the employee. The work efficiency computing sub-module 122 computes the work efficiency of the employee according to the products machining documents and stores the work efficiency in the performance assessing table of the employee. The work quality analyzing sub-module 123 stores the work quality of the employee in the performance assessing table of the employee. The performance report generating module 13 generates the performance report of the employee according to the work hours, the work efficiency and the work quality stored in the performance assessing table.

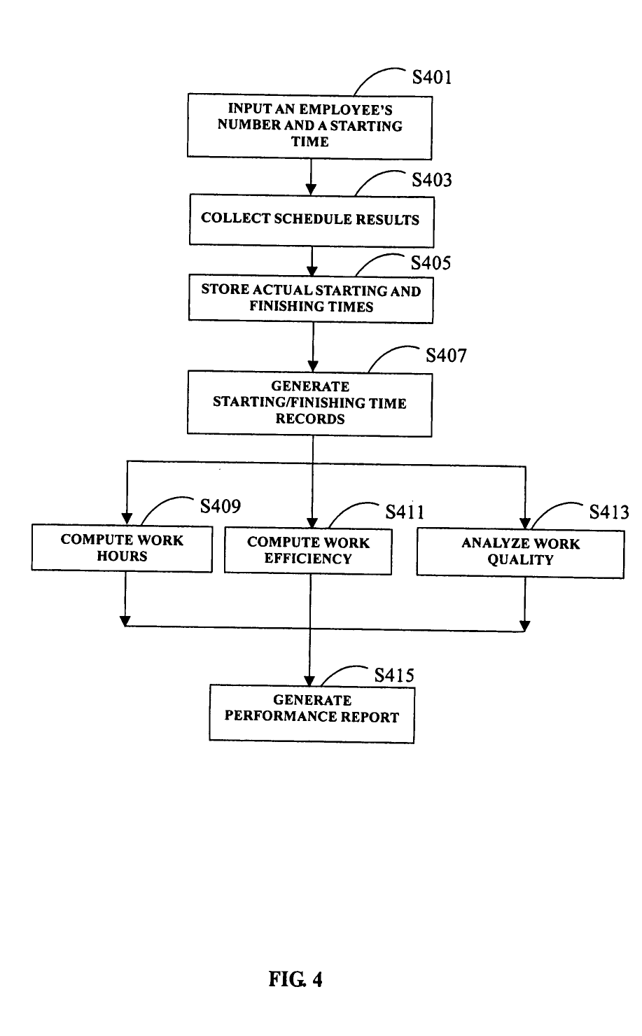

FIG. 4 is a flowchart of the preferred method for performance assessment of the present invention. In step S401, a user inputs an employee's number and a starting time of a product processed by the employee via one of the client computers 3. In step S403, the schedule results collecting sub-module 110 collects the daily schedule results from the product machining scheduling system 2, and stores the daily schedule results in the products machining documents. The stored results include the scheduled starting time and the scheduled finishing time of each product processed by the employee. In step S405, the finished products information maintaining sub-module 111 stores the actual starting time, the actual finishing time, and the machining status of each product processed by the employee in the products machining documents. The machining status may be unwrought, in progress, or finished. In step S407, the starting/finishing time record generating sub-module 120 generates the starting time record and the finishing time record according to the products machining documents. In step S409, the work hours computing sub-module 121 computes work hours of the employee, and stores the work hours in the performance table of the employee. In step S411, the work efficiency computing sub-module 122 computes work efficiency of the employee according to the products machining documents, and stores the work efficiency in the performance table of the employee. In step S413, the work quality analyzing sub-module 123 checks whether the products are behind or ahead of schedule according to the machining statuses of the products, and stores the results of such checking in the employee's performance assessing table. The work quality analyzing sub-module 123 also stores in the employee's performance assessing table the results of quality inspection of the products performed by an inspector. The quality inspection result of a product may be passed or rejected. All the results stored by the work quality analyzing sub-module 123 are collectively regarded as the work quality of the employee. In step S415, the performance report generating module 13 generates a report according to the work hours, the work efficiency, and the work quality of the employee stored in the performance assessing table.

In general, the performance assessing system and method of the present invention may take forms other than what is described above. While preferred embodiments for carrying out the invention have been described in detail, those familiar with the art to which the invention relates will recognize various alternative designs and embodiments for practicing the invention. These alternative embodiments are within the scope of the invention. The scope of the invention is defined by the claims appended hereto and allowable equivalents thereof.

What is claimed is:

1. A performance assessing system comprising a database and a plurality of client computers connected with an application server, the application server being connected with a product machining scheduling system, wherein:
the database stores a plurality of products machining documents and a plurality of performance assessing tables of employees; and
the application server comprises:
a machining status tracing module for collecting daily schedule results from the product machining scheduling system, storing the schedule results in a corresponding products machining document, and storing each product's machining status, actual starting time and actual finishing time in the products machining document;
a performance assessing module for generating a starting time record and a finishing time record for each product according to the products machining documents, computing an employee's work hours and work efficiency, analyzing the employee's work quality, and storing the starting time record, the finishing time record, the employee's work hours, the employee's work efficiency, and the employee's work quality in a corresponding employee performance assessing table; and
a performance report generating module for generating a performance report according to the work hours, the work efficiency, and the work quality of the employee stored in the performance assessing table.

2. The performance assessing system as described in claim 1, wherein the machining status tracing module comprises a schedule results collecting sub-module and a finished products information maintaining sub-module, wherein:
the schedule results collecting sub-module collects daily schedule results from the product machining scheduling system, and stores the schedule results in the products machining documents; and
the finished products information maintaining sub-module records and stores the actual starting times, the actual finishing times, and the machining statuses of the products in the performance assessing tables.

3. The performance assessing system as described in claim 1, wherein the performance assessing module comprises a starting/finishing time record generating sub-module, a work hours computing sub-module, a work efficiency computing sub-module, and a work quality analyzing sub-module, wherein:
the starting/finishing time record generating sub-module generates the starting time record and the finishing time record according to the products machining documents;
the work hours computing sub-module computes the work hours of the employee, and stores the work hours in the performance assessing table of the employee;
the work efficiency computing sub-module computes the work efficiency of the employee according to the products machining documents and stores the work efficiency in the performance assessing table of the employee; and
the work quality analyzing sub-module analyzes the work quality of the employee, and stores the work quality in the performance assessing table of the employee.

4. A performance assessing method, comprising the following steps:
receiving an employee's number and a starting time;
collecting daily schedule results, and storing the daily schedule results in a products machining document;
storing actual starting time, actual finishing time, and machining status of each of products in the products machining document;
generating a starting time record and a finishing time record according to the products machining document;
computing work hours of the employee, and storing the work hours in a performance assessing table of the employee;
computing a work efficiency of the employee, and storing the work efficiency in the performance assessing table of the employee;
analyzing a work quality of the employee, and storing the work quality in the performance assessing table of the employee; and
generating a performance report on the employee.

5. The performance assessing method as described in claim 4, wherein the daily schedule results comprise a scheduled starting time and a scheduled finishing time of each product.

6. The performance assessing method as described in claim 4, wherein the work hours is the sum of time periods of all the products finished by the employee, and the time period of each product is the time span between the actual start time and the actual finish time.

7. The performance assessing method as described in claim 4, wherein the work efficiency comprises a ratio of a scheduled work time and an actual work time for each of products finished by the employee.

8. The performance assessing method as described in claim 7, wherein the scheduled work time is the scheduled finishing time minus the scheduled starting time of the products finished by the employee.

9. The performance assessing method as described in claim 7, wherein the actual work time is the actual finishing time minus the actual starting time of the products finished by the employee.

10. The performance assessing method as described in claim 4, wherein the step of analyzing the work quality of the employee comprises:
checking whether the products are behind or ahead of schedule according to the machining statuses of the products in the performance assessing table of the employee, and storing the checking results in the performance assessing table of the employee; and
inspecting the quality of the products finished by the employee, and storing the inspection results in the performance assessing table of the employee.

11. The performance assessing method as described in claim 10, wherein the quality of the products checked may be passed or rejected.
